(19) United States
(12) Patent Application Publication
(10) Pub. No.: US 2025/0349963 A1
(43) Pub. Date: Nov. 13, 2025

(54) ELECTRICITY STORAGE DEVICE

(71) Applicant: TOYOTA JIDOSHA KABUSHIKI KAISHA, Aichi-ken (JP)

(72) Inventors: Shinya GOITSUKA, Nisshin-shi (JP); Hiroshi OTAKE, Toyota-shi (JP)

(21) Appl. No.: 19/170,060

(22) Filed: Apr. 4, 2025

(30) Foreign Application Priority Data
May 10, 2024 (JP) 2024-076962

(51) Int. Cl. H01M 50/262; H01M 50/204; H01M 50/289; H01M 50/507

(52) U.S. Cl. CPC H01M 50/262; H01M 50/204; H01M 50/289; H01M 50/507

(57) ABSTRACT

An electricity storage device includes a plurality of electricity storage modules, a plurality of cross members, and connecting brackets that connect adjacent electricity storage modules. The cross member extends in a Y-direction along each of the electricity storage modules arranged in the Y-direction. The cross member extends in an X-direction between electricity storage modules adjacent to each other in the Y-direction. Each of the connecting brackets is connected to each of the cross members.

### CROSS-REFERENCE TO RELATED APPLICATION

This application claims priority to Japanese Patent Application No. 2024-076962 filed on May 10, 2024, incorporated herein by reference in its entirety.

### BACKGROUND

### 1. Technical Field

The present disclosure relates to an electricity storage device.

### 2. Description of Related Art

Japanese Unexamined Patent Application Publication (Translation of PCT Application) No. 2022-516519 (JP 2022-516519 A) discloses a power battery pack including a battery tray and a plurality of unit cells mounted on the battery tray. A partition plate that partitions a battery storage space into a plurality of regions is provided on a bottom plate of the battery tray. A gas passage for allowing gas discharged from the unit cells to flow therethrough is formed inside the partition plate.

### SUMMARY

Here, it has been desired to improve the rigidity of a partition plate (partition member) in order to restrain exhaust of smoke through a gas passage from being disturbed due to damage to the partition plate or the like. Furthermore, since unit cells (electricity storage modules) are separated into a plurality of regions by the partition plate, it is considered that the rigidity (overall rigidity) of the unit cells is lower as compared with a case where the unit cells are collectively arranged in one region.

The present disclosure has been made to solve the above-mentioned problem, and has an object to provide an electricity storage device that can improve the rigidity of a partition member while improving the rigidity of the electricity storage module.

An electricity storage device according to an aspect of the present disclosure includes a plurality of electricity storage modules arranged in a first direction, a plurality of partition members that partition areas in which the electricity storage modules are respectively arranged, and a connecting member that connects electricity storage modules adjacent to each other in the first direction among the plurality of electricity storage modules. The partition members include a first partition member that extends in the first direction along each of the plurality of electricity storage modules arranged in the first direction, and a second partition member that extends in a second direction intersecting the first direction between the electricity storage modules adjacent to each other in the first direction. The connecting member is connected to each of the first partition member and the second partition member.

In the electricity storage device according to an aspect of the present disclosure, as described above, the connecting member for connecting the electricity storage modules to each other is connected to each of the first partition member and the second partition member. As a result, the electricity storage modules are connected to each other by the connecting member, whereby the rigidity of the electricity storage modules can be improved as compared with a case where the electricity storage modules are independent of one another. Furthermore, since the first partition member and the second partition member are connected to each other via the connecting member, the rigidity of the partition members can be improved as compared with a case where the first partition member and the second partition member are independent of each other. Therefore, the rigidity of the partition members can be improved while improving the rigidity of the electricity storage modules.

The electricity storage device may be provided with a bus bar that electrically connects the electricity storage modules adjacent to each other in the first direction. The bus bar may be provided below the connecting member. With this configuration, the bus bar and the connecting member are provided at different positions in an up-down direction, so that the first partition member and the second partition member can be connected to each other by the connecting member while restraining interference between the bus bar and the connecting member. As a result, the rigidity of the partition members can be improved while restraining the interference between the bus bar and the connecting member.

The electricity storage device may be equipped with a lower case in which each of the partition members is provided. The first partition member may have an upper end portion to be connected to the connecting member, a lower end portion to be connected to the lower case, and a side surface portion that connects the upper end portion and the lower end portion to each other, and extend in the first direction so as to span the plurality of electricity storage modules arranged in the first direction. A gap may be formed between the side surface portion of the first partition member and the second partition member. The bus bar may be provided so as to extend through the gap in the first direction between the lower case and the connecting member. With this configuration, the electricity storage modules can be easily electrically connected to each other by the bus bar through the gap formed between the lower case and the connecting member.

Each of the plurality of electricity storage modules may include a first end surface and a second end surface arranged in the second direction. The first partition member may include one first partition member extending in the first direction along the first end surface, and another first partition member extending in the first direction along the second end surface. The connecting member may include one connecting member to be connected to each of the second partition member and the one first partition member, and another connecting member to be connected to each of the second partition member and the other first partition member. With this configuration, each of the one first partition member and the other first partition member can be connected to the second partition member by the one connecting member and the other connecting member. As a result, the rigidity of the partition members can be improved as compared with a case where only one of the one first partition member and the other first partition member is connected to the second partition member.

The electricity storage device may be provided with a plurality of fastening members. Each of the fastening members may include a head portion and a shaft portion connected to the head portion. Each of the plurality of electricity storage modules may include a first side surface and a second side surface arranged in the first direction. The second partition member may include one second partition member extending in the second direction along the first side surface, and another second partition member extending in the second direction along the second side surface. The one connecting member may include a first connecting piece for connecting the one first partition member and the one second partition member to each other, and a second connecting piece for connecting the one first partition member and the other second partition member to each other. The other connecting member may include a third connecting piece for connecting the other first partition member and the one second partition member to each other. The fastening members may include a first fastening member for fastening the first connecting piece and the one first partition member to each other, a second fastening member for fastening the first connecting piece and the one second partition member to each other, a third fastening member for fastening the second connecting piece and the one first partition member, and a fourth fastening member for fastening the third connecting piece and the one second partition member. The distance between the first fastening member and the third fastening member may be smaller than the distance between the second fastening member and the fourth fastening member. Each of the length of the shaft portion of the first fastening member and the length of the shaft portion of the third fastening member may be smaller than each of the length of the shaft portion of the second fastening member and the length of the shaft portion of the fourth fastening member.

Here, the linear expansion amount of a member increases as the distance between fastening points of the member increases. Also, the limit slippage amount of the member is larger as the length of the shaft portion of the fastening member increases. Therefore, with the configuration as described above, in a configuration in which the linear expansion amount of one second partition member is relatively large, the limit slippage amount of the fastening member to be fastened to one second partition member can be made relatively large.

According to the present disclosure, the rigidity of the partition members can be improved while improving the rigidity of the electricity storage modules.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a configuration of an electricity storage device according to an embodiment;

FIG. 2 is a plan view showing the configuration of the electricity storage device according to the embodiment;

FIG. 3 is a partially enlarged view of an electricity storage module of FIG. 2;

FIG. 4 is a sectional view taken along line IV-IV in FIG. 2;

FIG. 5 is a sectional view taken along line V-V in FIG. 2; and

FIG. 6 is a sectional view taken along line VI-VI in FIG. 3.

### DETAILED DESCRIPTION OF EMBODIMENTS

An embodiment of the present disclosure will be described with reference to the drawings. In the drawings which will be hereunder referred to, the same or corresponding components are designated by the same reference signs.

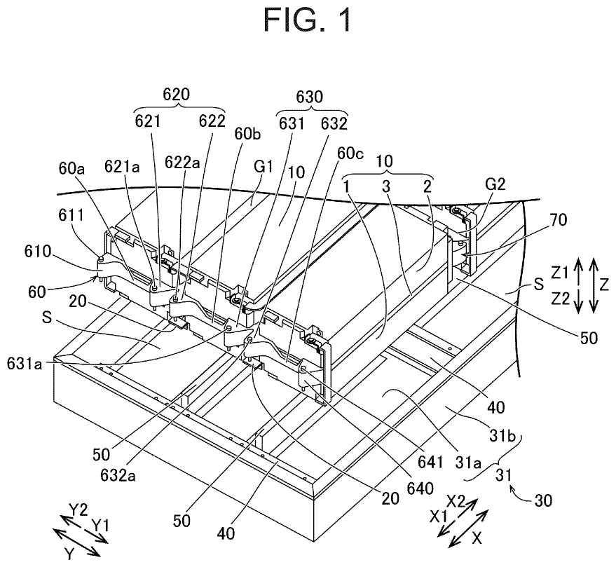

An electricity storage device 100 according to an embodiment of the present disclosure will be described with reference to FIG. 1 to FIG. 6. FIG. 1 is a perspective view showing the electricity storage device 100 according to the present embodiment. The electricity storage device 100 is mounted, for example, in a hybrid electric vehicle, a plug-in hybrid electric vehicle, a battery electric vehicle or the like. Note that the use of the electricity storage device 100 is not limited to the use of vehicles.

In the present specification, an X-direction, a Y-direction, and a Z-direction are directions which are orthogonal to one another. For example, the X-direction and the Y-direction are a front-rear direction and a width direction with respect to a vehicle when the electricity storage device 100 is mounted on the vehicle, respectively. An X1-direction and an X2-direction are a forward direction and a rearward direction with respect to the vehicle, respectively. A Y1-direction and a Y2-direction are a leftward direction and a rightward direction with respect to the vehicle, respectively. Furthermore, the Z-direction is an up-down (vertical) direction. The X-direction and the Y-direction are examples of “second direction” and “first direction” of the present disclosure, respectively.

As shown in FIG. 1, the electricity storage device 100 includes a plurality of electricity storage modules 10, a plurality of bus bars 20, a case 30, a plurality of cross members 40, a plurality of cross members 50, a connecting bracket 60, and a connecting bracket 70. The case 30 accommodates the electricity storage modules 10. Note that the cross member 40 is an example of “partition member” and “first partition member” in the present disclosure. The cross member 50 is an example of “partition member” and “second 30 partition member” in the present disclosure. Furthermore, the connecting bracket 60 is an example of “connecting member” and “one connecting member” in the present disclosure. The connecting bracket 70 is an example of “connecting member” and “the other connecting member” in the present disclosure.

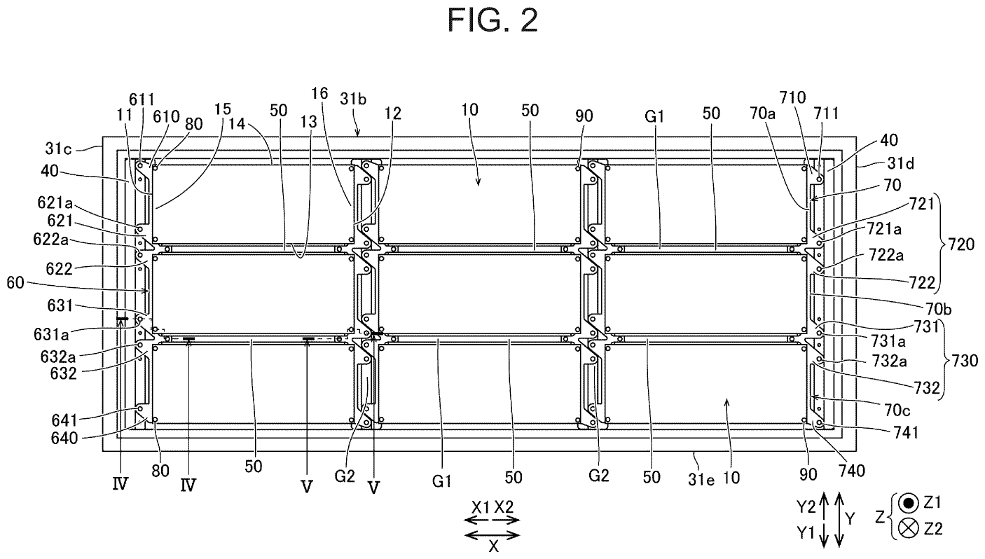

As shown in FIG. 2, the electricity storage modules 10 are arranged in a matrix (3×3) form on an XY plane when viewed from a Z1 side. Specifically, three sets each including three electricity storage modules 10 arranged in the Y-direction are arranged in the X-direction.

Referring to FIG. 1 again, each electricity storage module 10 includes a lower module 1, an upper module 2, and a cooler 3. The lower module 1, the cooler 3, and the upper module 2 are stacked in this order from the bottom.

A gap G1 is provided between the electricity storage modules 10 adjacent to each other in the Y-direction. A gap G2 is provided between the electricity storage modules 10 adjacent to each other in the X-direction.

The bus bar 20 connects the electricity storage modules 10 adjacent to each other in the Y-direction (the lower modules 1). The electricity storage modules 10 adjacent to each other in the Y-direction are electrically connected to each other by the bus bar 20.

The case 30 includes a lower case 31. The lower case 31 is provided so as to cover the electricity storage modules 10 from below.

The lower case 31 has a bottom surface portion 31a and a peripheral wall portion 31b. The bottom surface portion 31a is provided below the electricity storage modules 10. The bottom surface portion 31a is provided so as to cover the electricity storage modules 10 from below.

The peripheral wall portion 31b is provided so as to extend upward from an outer peripheral edge portion of the bottom surface portion 31a. The peripheral wall portion 31b is provided in an annular shape so as to surround the electricity storage modules 10.

The cross members 40 and the cross members 50 extend to be orthogonal to each other. The cross members 40 and the cross members 50 are provided to partition an area in the lower case 31 where the electricity storage modules 10 are arranged. Each of the cross members 40 and the cross members 50 is fixed (for example, welded) to the bottom surface portion 31a of the lower case 31. A smoke exhaust passage through which gas and smoke flow is formed inside each of the cross members 40 and 50.

Each of the cross members 40 extends in the Y-direction along each of the three electricity storage modules 10 arranged in the Y-direction. Specifically, each of the cross members 40 extends in the Y-direction so as to span the three electricity storage modules 10 arranged in the Y-direction. The cross members 40 are arranged to be spaced from one another in the X-direction.

Each of the cross members 50 extends in the X-direction. The cross members 50 are provided in each of a plurality of spaces S which are formed between the cross members 40 adjacent to each other in the X-direction. In other words, the cross members 50 arranged in different spaces S are separated by the cross members 40. In each of the spaces S, two cross members 50 are arranged to be spaced from each other in the Y-direction.

Each of the connecting brackets 60 and 70 connects the electricity storage modules 10 adjacent to each other in the Y-direction. Specifically, each of the connecting brackets 60 and 70 connects three electricity storage modules 10 arranged in the Y-direction to one another. Each of the connecting brackets 60 and 70 extends in the Y-direction so as to span the three electricity storage modules 10 described above. Each of the connecting brackets 60 is provided on the X1 side with respect to the three electricity storage modules 10. Each of the connecting brackets 70 is provided on the X2 side with respect to the three electricity storage modules 10.

Here, it is desirable to improve the rigidity of the cross members in order to restrain exhaust of smoke through the smoke exhaust passage to be disturbed due to damage to the cross members, etc. Furthermore, since the electricity storage modules are separated into a plurality of areas by the cross members, it is considered that the rigidity (overall rigidity) of the electricity storage modules are lower as compared with a case where the electricity storage modules are installed all together in one area.

Therefore, in the present embodiment, the connecting bracket 60 and the connecting bracket 70 are connected to the cross member 40 and the cross member 50, respectively. As a result, the cross members 40 and the cross members 50 are connected together via each of the connecting brackets 60 and 70, whereby the entire rigidity of the connecting brackets is improved. Details will be described below. Note that each of the connecting brackets 60 and 70 may be made of aluminum, for example.

Each of the connecting brackets 60 includes a connecting piece 610, a connecting piece 620, a connecting piece 630, and a connecting piece 640. Note that the connecting piece 630 and the connecting piece 620 are examples of “first connecting piece” and “second connecting piece” of the present disclosure, respectively.

Each connecting bracket 60 includes a connecting portion 60a, a connecting portion 60b, and a connecting portion 60c. The connecting portion 60a connects the connecting piece 610 and the connecting piece 620 to each other. The connecting portion 60b connects the connecting piece 620 and the connecting piece 630 to each other. The connecting portion 60c connects the connecting piece 630 and the connecting piece 640 to each other. Each of the connecting portion 60a, the connecting portion 60b, and the connecting portion 60c extends in the Y-direction.

The connecting piece 620 has a piece portion 621 and a piece portion 622 that are connected to each other. The connecting piece 630 has a piece portion 631 and a piece portion 632 that are connected to each other.

The connecting piece 610 is disposed in the vicinity of an end portion on the Y2-side of an electricity storage module 10 which is closest to the Y2-side (hereinafter referred to as a Y2-side electricity storage module 10) among the three electricity storage modules 10 arranged in the Y-direction. The piece portion 621 is disposed in the vicinity of an end portion on the Y1-side of the Y2-side electricity storage module 10.

The piece portion 622 is disposed in the vicinity of an end portion on the Y2-side of an electricity storage module 10 at the center of the three electricity storage modules 10 arranged in the Y-direction (hereinafter referred to as a central electricity storage module 10). The piece portion 631 is disposed in the vicinity of an end portion on the Y1-side of the central electricity storage module 10.

The piece portion 632 is disposed in the vicinity of an end portion on the Y2-side end of an electricity storage module 10 which is closest to the Y1-side (hereinafter referred to as a Y1-side electricity storage module 10) among the three electricity storage modules 10 arranged in the Y-direction. The connecting piece 640 is disposed in the vicinity of an end portion on the Y1-side of the Y1-side electricity storage module 10.

The electricity storage device 100 includes a bolt 611, a bolt 621a, a bolt 622a, a bolt 631a, a bolt 632a, and a bolt 641. The bolt 611, the bolt 621a, the bolt 622a, the bolt 631a, the bolt 632a, and the bolt 641 fasten the connecting piece 610, the piece portion 621, the piece portion 622, the piece portion 631, the piece portion 632, and the connecting piece 640 to the cross members 40, respectively. Note that the bolt 631a is an example of “first fastening member” and “fastening member” of the present disclosure. Also, the bolt 622a is an example of “third fastening member” and “fastening member” of the present disclosure.

FIG. 2 is a plan view of the electricity storage device 100. Each of the electricity storage modules 10 has a side surface 11, a side surface 12, a side surface 13, and a side surface 14. The side surface 11 and the side surface 12 are arranged in the X-direction. The side surface 11 and the side surface 12 are an end face on the X1-side and an end face on the X2-side of the electricity storage module 10, respectively. The side surface 13 and the side surface 14 are arranged in the Y-direction. The side surface 13 and the side surface 14 are an end surface on the Y1-side and an end surface on the Y2-side of the electricity storage module 10, respectively. The side surface 11 and the side surface 12 are examples of “first end surface” and “second end surface” of the present disclosure, respectively. Furthermore, the side surface 13 and the side surface 14 are examples of “first side surface” and “second side surface” of the present disclosure, respectively.

Each connecting bracket 60 extends in the Y direction so as to follow the side surface 11 of each of the three electricity storage modules 10 arranged in the Y direction. Each connecting bracket 70 extends in the Y direction so as to follow a side surface 12 of each of the three electricity storage modules 10 arranged in the Y-direction.

The peripheral wall portion 31b of the lower case 31 includes a side wall 31c, a side wall 31d, a side wall 31e, and a side wall 31f. The side wall 31c extends in the

Y-direction on the X1 side of the electricity storage modules 10. The side wall 31d extends in the Y-direction on the X2 side of the electricity storage modules 10. The side wall 31e extends in the X-direction on the Y1 side of the electricity storage modules 10. The side wall 31f extends in the X-direction on the Y2 side of the electricity storage modules 10. Note that a smoke exhaust valve (not shown) may be provided on the peripheral wall portion 31b (for example, the side wall 31c).

Nine partitioned regions are defined by the cross members 40 and the cross members 50 in the lower case 31. Each of the electricity storage modules 10 is disposed in each of the nine regions. The cross members 40 and the cross members 50 may be formed of, for example, iron. Furthermore, the number and arrangement of the electricity storage modules 10 are not limited to the example described above.

The cross members 40 are respectively provided in the gaps G2 between adjacent electricity storage modules 10 in the X-direction, the gaps between the electricity storage modules 10 and the side wall 31c, and the gaps between the electricity storage modules 10 and the side wall 31d. The cross members 40 are provided so as to extend in the Y-direction along each of the side surfaces 11 and 12 of the electricity storage modules. The cross member 40 along the side surface 11 is an example of “one first partition member” in the present disclosure. Furthermore, the cross member 40 along the side surface 12 is an example of “the other first partition member” in the present disclosure.

The cross members 50 are provided so as to extend in the X-direction in the gap G1 between electricity storage modules 10 adjacent to each other in the Y direction. In other words, each of the cross members 50 extends in the X-direction along each of the side surfaces 13 and 14 of the central electricity storage module 10 out of the three electricity storage modules 10 arranged in the Y-direction. The cross member 50 on the Y1 side and the cross member 50 on the Y2 side are examples of “one second partition member” and “the other second partition member” of the present disclosure, respectively.

Each connecting bracket 70 includes a connecting piece 710, a connecting piece 720, a connecting piece 730, and a connecting piece 740. Note that the connecting piece 730 is an example of “third connecting piece” in the present disclosure.

Each connecting bracket 70 includes a connecting portion 70a, a connecting portion 70b, and a connecting portion 70c. The connecting portion 70a connects the connecting piece 710 and the connecting piece 720 to each other. The connecting portion 70b connects the connecting piece 720 and the connecting piece 730 to each other. The connecting portion 70c connects the connecting piece 730 and the connecting piece 740 to each other. Each of the connecting portion 70a, the connecting portion 70b, and the connecting portion 70c extends in the Y-direction.

The connecting piece 720 has a piece portion 721 and a piece portion 722 that are connected to each other. The connecting piece 730 has a piece portion 731 and a piece portion 732 that are connected to each other.

The connecting piece 710 is disposed in the vicinity of an end portion on the Y2 side of the electricity storage module 10 located on the Y2 side. The piece portion 721 is located in the vicinity of an end portion on the Y1 side of the electricity storage module 10 located on the Y2 side.

The piece portion 722 is disposed in the vicinity of an end portion on the Y2-side of the central electricity storage module 10. The piece portion 731 is disposed in the vicinity of an end portion on the Y1-side of the central electricity storage module 10.

The piece portion 732 is disposed in the vicinity of an end portion on the Y2-side of the Y1-side electricity storage module 10. The connecting piece 740 is disposed in the vicinity of an end portion on the Y1-side of the Y1-side electricity storage module 10.

The electricity storage device 100 includes a bolt 711, a bolt 721a, a bolt 722a, a bolt 731a, a bolt 732a, and a bolt 741. The bolt 711, the bolt 721a, the bolt 722a, the bolt 731a, the bolt 732a, and the bolt 741 fasten the connecting piece 710, the piece portion 721, the piece portion 722, the piece portion 731, the piece portion 732, and the connecting piece 740 to the cross members 40, respectively.

Each of the electricity storage modules 10 has a connecting portion 15 and a connecting portion 16. The connecting portion 15 is provided so as to extend in the Y-direction at an end portion on the X1 side of each electricity storage module 10. The connecting portion 16 is provided so as to extend in the Y-direction at an end portion on the X2 side of each electricity storage module 10.

The electricity storage device 100 includes a plurality of bolts 80 and a plurality of bolts 90. The bolt 80 fastens the connecting portion 15 and the connecting bracket 60 to each other. The bolt 90 fastens the connecting portion 16 and the connecting bracket 70 to each other. Details will be described later.

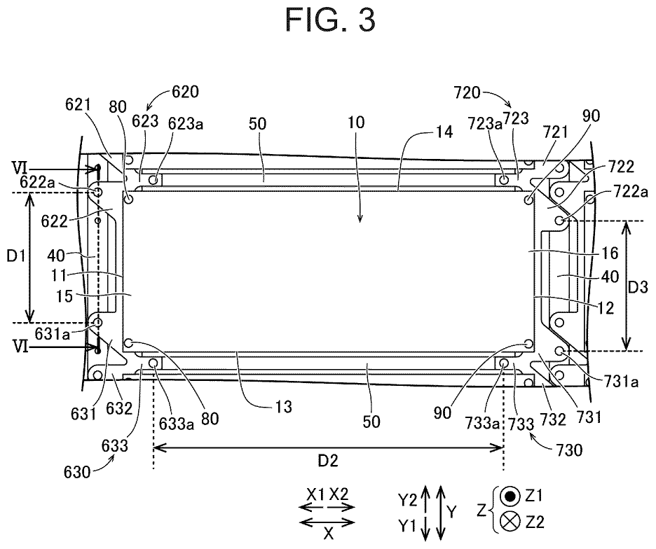

As shown in FIG. 3, the connecting piece 620 has a connection piece portion 623. The connection piece portion 623 connects the piece portion 621 and the piece portion 622 to each other. The connecting piece 630 has a connection piece portion 633. The connecting piece portion 633 connects the piece portion 631 and the piece portion 632 to each other.

The electricity storage device 100 includes a bolt 623a and a bolt 633a. The

bolt 623a fastens the connection piece portion 623 to an end portion on the X1 side of the cross member 50 (following the side surface 14). The bolt 633a fastens the connection piece portion 633 to an end portion on the X1 side of the cross member 50 (following the side surface 13). Note that the bolt 633a is an example of “second fastening member” and “fastening member” in the present disclosure.

The connecting piece 720 has a connection piece portion 723. The connection piece portion 723 connects the piece portion 721 and the piece portion 722 to each other. The connecting piece 730 has a connection piece portion 733. The connection piece portion 733 connects the piece portion 731 and the piece portion 732 to each other.

T electricity storage device 100 includes a bolt 723a and a bolt 733a. The bolt 723a fastens the connection piece portion 723 to an end portion on the X2 side of the cross member 50 (following the side surface 14). The bolt 733a fastens the connection piece portion 733 to an end portion on the X2 side of the cross member 50 (following the side surface 13). Note that the bolt 733a is an example of “fourth fastening member” and “fastening member” of the present disclosure.

The distance D1 between the bolt 622a and the bolt 631a is smaller than the distance D2 between the bolt 633a and the bolt 733a. Furthermore, the distance D3 between the bolt 722a and the bolt 731a is smaller than the distance D2. Note that the distance D1 may be equal to the distance D3.

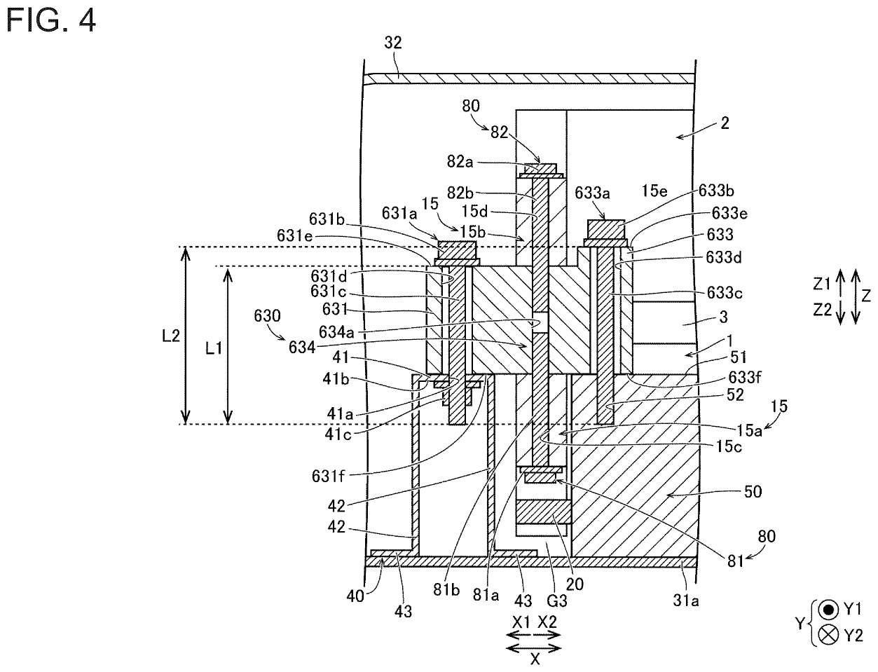

FIG. 4 is a sectional view taken along line IV-IV in FIG. 2. The cross member 40 has a hat-like shape in a sectional view taken along the X-direction. Specifically, the cross member 40 has an upper end surface portion 41, a pair of side surface portions 42, and a pair of flange portions 43. The side surface portion 42 connects the upper end surface portion 41 and the flange portion 43 to each other. One and the other of the pair of side surface portions 42 are provided so as to extend downward from an end portion on the X1 side and an end portion on the X2 side of the upper end surface portion 41, respectively. One flange portion 43 on the X1 side of the pair of flange portions 43 extends from the lower end portion of the side surface portion 42 to the X1 side. The other flange portion 43 on the X2 side of the pair of flange portions 43 extends from the lower end portion of the side surface portion 42 to the X2 side. Each of the pair of flange portions 43 is connected (for example, welded) to the lower case 31. Note that the upper end surface portion 41 and the flange portion 43 are examples of “upper end portion” and “lower end portion” of the present disclosure, respectively.

The bolt 631a has a head portion 631b and a shaft portion 631c connected to the head portion 631b. The shaft portion 631c extends downward from the head portion 631b. Note that each of the bolts 611, 621a, 622a, 632a, and 641 (FIG. 2) has the same shape and size as the bolt 631a.

A through-hole 631d is formed in the piece portion 631. A through-hole 41a is formed in the upper end surface portion 41 of the cross member 40. The shaft portion 631c of the bolt 631a passes through the through-hole 631d and the through-hole 41a. Note that the bolt 631a is fixed to the lower surface 41b of the upper end surface portion 41 by a nut 41c. As a result, the piece portion 631 is fixed to the upper end surface portion 41 of the cross member 40. The head portion 631b of the bolt 631a is fixed to the upper surface 631e of the piece portion 631.

The bolt 633a has a head portion 633b and a shaft portion 633c connected to the head portion 633b. The shaft portion 633c extends downward from the head portion 633b. Note that the bolt 623a (FIG. 3) has the same shape and size as the bolt 633a.

A through-hole 633d is formed in the piece portion 633. A bolt insertion hole 52 is formed in the cross member 50. The bolt insertion hole 52 is formed in a portion in the vicinity of an end portion on the X1 side of the upper surface 51 of the cross member 50. The bolt insertion hole 52 has been subjected to threading. The shaft portion 633c of the bolt 633a penetrates through the through-hole 633d, and is inserted into the bolt insertion hole 52, whereby the piece portion 633 is fixed to the cross member 50. The head portion 633b of the bolt 633a is fixed to the upper surface 633e of the piece portion 633. The upper surface 633e is provided above the upper surface 631e of the piece portion 631. The lower surface 631f of the piece portion 631 and the lower surface 633f of the piece portion 633 are provided at the same position in the Z-direction.

The connecting piece 630 has a piece portion 634. The piece portion 634 is provided between the piece portion 631 and the piece portion 633. A through-hole 634a extending in the Z-direction is formed in the piece portion 634. The through-hole 634a is subjected to threading. Note that each of the connecting piece 610, the piece portion 621, the piece portion 622, the piece portion 632, and the connecting piece 640 is provided with a portion similar to the piece portion 634.

The connecting portion 15 of the electricity storage module 10 includes a lower connecting portion 15a and an upper connecting portion 15b. The lower connecting portion 15a and the upper connecting portion 15b are provided in the lower module 1 and the upper module 2, respectively. A through-hole 15c and a through-hole 15d which extend in the Z direction are formed in the lower connecting portion 15a and the upper connecting portion 15b, respectively.

The bolt 80 includes a bolt 81 and a bolt 82. The bolt 81 has a head portion 81a and a shaft portion 81b extending upward from the head portion 81a. The shaft portion 81b penetrates through the through-hole 15c of the lower connecting portion 15a, and is inserted into the through-hole 634a of the piece portion 634 from below. The bolt 82 has a head portion 82a and a shaft portion 82b extending downward from the head portion 82a. The shaft portion 82b penetrates through the through-hole 15d of the upper connecting portion 15b, and is inserted into the through-hole 634a of the piece portion 634 from above. In this way, the piece portion 634 is fixed to the connecting portion 15 of the electricity storage module 10.

The shaft portion 631c of the bolt 631a has a length L1 in the Z-direction. The shaft portion 633c of the bolt 633a has a length L2 in the Z-direction. The length L2 is larger than the length L1.

The bus bar 20 is provided below the connecting bracket 60 (connecting piece 630). Specifically, a gap G3 is formed between the side surface portion 42 of the cross member 40 (the side surface portion 42 on the cross member 50 side) and the cross member 50. The bus bar 20 is provided so as to pass through the gap G3 and extend in the Y direction between the lower case 31 and the connecting bracket 60 (connecting piece 630). The configuration of the bus bar 20 below the connecting piece 620 is similar. As shown in FIG. 4, the bus bar 20 extends in the Y direction below the connecting portion 15 (lower connecting portion 15a).

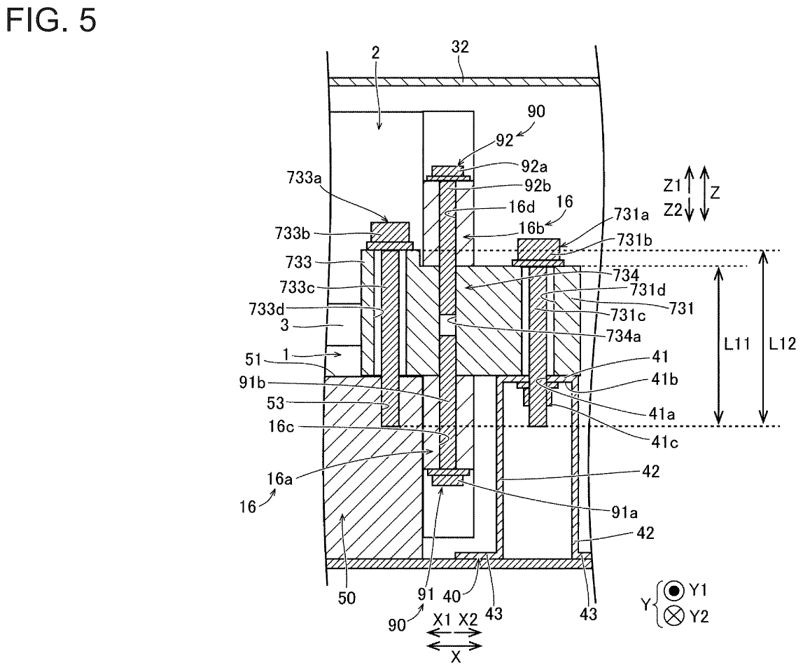

FIG. 5 is a sectional view taken along line V-V in FIG. 2. The configuration in FIG. 5 is substantially the same as that in FIG. 4. The bolt 731a has a head portion 731b and a shaft portion 731c extending downward from the head portion 731b. Note that each of the bolts 711, 721a, 722a, 732a, and 741 (FIG. 2) has the same shape and size as bolt 731a.

A through-hole 731d is formed in the piece portion 731. A shaft portion 731c of the bolt 731a penetrates through the through-hole 731d and the through-hole 41a. The bolt 731a is fixed to the lower surface 41b of the upper end surface portion 41 by a nut 41c, whereby the piece portion 731 is fixed to the upper end surface portion 41 of the cross member 40.

The bolt 733a has a head portion 733b and a shaft portion 733c extending downward from the head portion 733b. Note that the bolt 723a (FIG. 3) has the same shape and size as the bolt 733a.

A through-hole 733d is formed in the piece portion 733. A bolt insertion hole 53 is formed in the cross member 50. The bolt insertion hole 53 is formed in a portion in the vicinity of an end portion on the X2 side of the upper surface 51 of the cross member 50. The bolt insertion hole 53 has been subjected to threading. The shaft portion 733c of the bolt 733a penetrates through the through-hole 733d, and is inserted into the bolt insertion hole 53. In this way, the piece portion 733 is fixed to the cross member 50.

The connecting piece 730 has a piece portion 734. The piece portion 734 is provided between the piece portion 731 and the piece portion 733. A through-hole 734a extending in the Z-direction is formed in the piece portion 734. The through-hole 734a has been subjected to threading. Note that each of the connecting piece 710, the piece portion 721, the piece portion 722, the piece portion 732, and the connecting piece 740 also has a portion similar to the piece portion 734.

The connecting portion 16 of the electricity storage module 10 includes a lower connecting portion 16a and an upper connecting portion 16b. The lower connecting portion 16a and the upper connecting portion 16b are provided in the lower module 1 and the upper module 2, respectively. A through-hole 16c and a through-hole 16d which extend in the Z-direction are formed in the lower connecting portion 16a and the upper connecting portion 16b, respectively.

The bolt 90 includes a bolt 91 and a bolt 92. The bolt 91 has a head portion 91a, and a shaft portion 91b extending upward from the head portion 91a. The shaft portion 91b penetrates through the through-hole 16c of the lower connecting portion 16a, and is inserted from below into the through-hole 734a of the piece portion 734. The bolt 92 has a head portion 92a, and a shaft portion 92b extending downward from the head portion 92a. The shaft portion 92b penetrates through the through-hole 16d of the upper connecting portion 16b, and is inserted into the through-hole 734a of the piece portion 734 from above. In this way, the piece portion 734 is fixed to the connecting portion 16 of the electricity storage module 10.

The shaft portion 731c of the bolt 731a has a length L11 in the Z-direction. The shaft portion 733c of the bolt 733a has a length L12 in the Z-direction. The length L12 is larger than the length L11. Note that the length L11 and the length L12 are equal to the length L1 (FIG. 4) of the shaft portion 631c of the bolt 631a, and the length L2 (FIG. 4) of the shaft portion 633c of the bolt 633a, respectively. Therefore, the length L1 is smaller than each of the length L2 and the length L12.

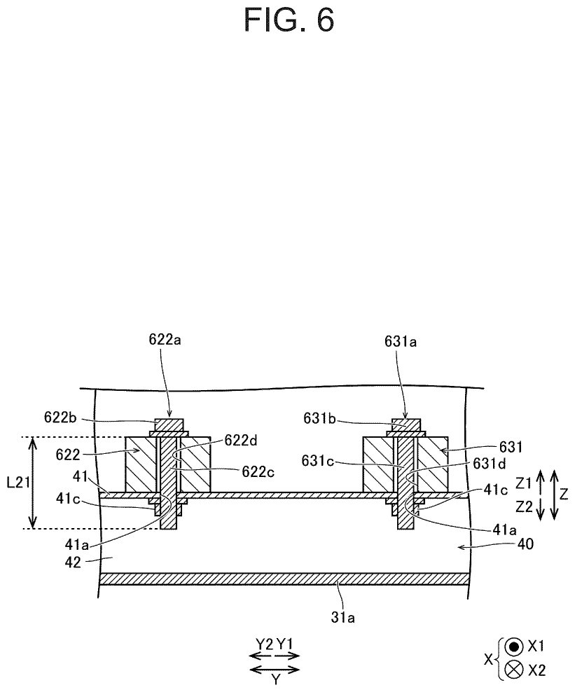

FIG. 6 is a sectional view taken along line VI-VI in FIG. 3. As shown in FIG. 6, the bolt 622a has a head portion 622b, and a shaft portion 622c extending downward from the head portion 622b.

A through-hole 622d is formed in the piece portion 622. Like the shaft portion 631c, the shaft portion 622c penetrates through the through-hole 622d and the through-hole 41a of the cross member 40, and is fixed to the upper end surface portion 41 of the cross member 40 by a nut 41c.

The shaft portion 622c has a length L21 in the Z-direction. The length L21 is equal to the length L1 (FIG. 4) of the shaft portion 631c of the bolt 631a. Therefore, the length L21 is smaller than each of the length L2 (FIG. 4) of the shaft portion 633c of the bolt 633a and the length L12 (FIG. 5) of the shaft portion 733c of the bolt 733a.

Here, the linear expansion amount of the cross member increases as the length of the cross member (the length between the fastening portions) increases according to the following formula (1). Therefore, since the distance D2 is larger than the distance D1 (FIG. 3), the linear expansion amount of the cross member 50 is larger than the linear expansion amount of the cross member 40. Note that in the following formula (1), ΔT, α, L, and ΔT represent a linear expansion amount, a linear expansion coefficient, the length of the cross member, and temperature change amount, respectively.

ΔL=α×L×ΔT (1)

Furthermore, a limit slippage amount of the bolt (an amount of slippage that can maintain fastening) increases as the length of the shaft portion of the bolt increases according to the following formula (2). Therefore, since each of the length L1 of the shaft portion 631c (FIG. 4) and the length L21 of the shaft portion 622c (FIG. 6) is smaller than each of the length L2 of the shaft portion 633c (FIG. 4) and the length L12 of the shaft portion 733c (FIG. 5), the limit slippage amount of each of the bolt 633a and the bolt 733a to be fastened to the cross member 50 becomes larger than the limit slippage amount of each of the bolt 631a and the bolt 622a to be fastened to the cross member 40. In the following formula (2), Scr, ΔT, Lc, L_{eng}, F₀, μ_{wg}, E_{B}, and I_{B} represent the limit slippage amount, the inner diameter of a fastened object (a nut, a bolt fastening hole, etc.) to be fastened to the shaft portion of the bolt, the length of a portion of the shaft portion which is not fastened to the fastened object, the length of a portion of the shaft portion which is fastened to the fastened object, a bolt axial force, a friction coefficient between the head portion and the seating surface of the bolt, a longitudinal elastic modulus of the bolt, and a geometrical moment of inertia of the bolt.

Scr=ΔT(2Lc+L_{eng})/L_{eng}+F₀μ_{wg}L_{c}³/6E_{B}I_{B} (2)

As a result, the limit slippage amount of the bolts (633a, 733a) to be fastened to the cross member 50 which has a relatively large linear expansion amount is relatively large, so that the linear expansion amount of the cross member can be easily absorbed by the bolt slippage (elastic deformation) amount.

The limit slippage amount is larger as the ratio (Lb/La) of the length (Lb) of a portion of the shaft portion that is not fastened to a nut or the like to the length (La) of a portion of the shaft portion that is fastened to a nut or the like is larger. Therefore, the limit slippage amount of the bolt to be fastened to the cross member 50 may be made larger than the limit slippage amount of the bolt to be fastened to the cross member 40 by adjusting the ratio. In this case, the entire lengths of the shaft portions of the respective bolts may be set to be the same or different from one another.

As described above, in the present embodiment, the connecting bracket 60 (70) that connects the electricity storage modules 10 together is connected to each of the cross members 40 and the cross members 50, which makes it possible for the connecting brackets 60 (70) to integrally connect the cross members 40 and 50 to the electricity storage modules 10 via the connecting brackets 60 (70). As a result, the rigidity of the cross members 40 (50) can be improved while improving the rigidity of the electricity storage modules 10. Furthermore, as compared with a case where members for connecting the electricity storage modules 10 together and members for connecting the cross members 40 and the cross members 50 together are different from each other, the number of parts of the electricity storage device 100 can be reduced and the configuration of the electricity storage device 100 can be simplified.

The embodiment shows an example in which the bus bars 20 are provided below the connecting brackets 60, but the present disclosure is not limited to this example. The bus bars may be provided above the connecting brackets 60.

The embodiment shows an example in which the connecting bracket 60 and the connecting bracket 70 are provided along the electricity storage modules 10, but the present disclosure is not limited to this example. Only one of the connecting bracket 60 and the connecting bracket 70 may be provided.

The embodiment shows an example in which the electricity storage module 10 includes the upper module 2 and the lower module 1, but the present disclosure is not limited to this example. The electricity storage module is not required to be divided into an upper module and a lower module.

Note that the configurations of the embodiment and the modifications described above may be combined with each other.

It should be noted that the embodiment disclosed herein is illustrative in all respects, and it should not be considered to be limited. The scope of the present disclosure is indicated, not by the description of the embodiment, but by the claims, and further includes all modifications within the claims and meanings equivalent to the claims.

What is claimed is:

1. An electricity storage device comprising:
a plurality of electricity storage modules arranged in a first direction;
a plurality of partition members that partition areas in which the electricity storage modules are respectively arranged; and
a connecting member that connects electricity storage modules adjacent to each other in the first direction among the plurality of electricity storage modules, wherein the partition members include:
a first partition member that extends in the first direction along each of the plurality of electricity storage modules arranged in the first direction; and
a second partition member that extends in a second direction intersecting the first direction between the electricity storage modules adjacent to each other in the first direction, the connecting member being connected to each of the first partition member and the second partition member.

2. The electricity storage device according to claim 1, further comprising a bus bar that electrically connects the electricity storage modules adjacent to each other in the first direction, wherein the bus bar is provided below the connecting member.

3. The electricity storage device according to claim 2, further comprising a lower case in which each of the partition members is provided, wherein:
the first partition member has an upper end portion to be connected to the connecting member, a lower end portion to be connected to the lower case, and a side surface portion that connects the upper end portion and the lower end portion to each other, and extends in the first direction so as to span the plurality of electricity storage modules arranged in the first direction;
a gap is formed between the side surface portion of the first partition member and the second partition member; and
the bus bar is provided so as to extend through the gap in the first direction between the lower case and the connecting member.

4. The electricity storage device according to claim 1, wherein:
each of the plurality of electricity storage modules includes a first end surface and a second end surface arranged in the second direction;
the first partition member includes one first partition member extending in the first direction along the first end surface, and another first partition member extending in the first direction along the second end surface; and
the connecting member includes one connecting member to be connected to each of the second partition member and the one first partition member, and another connecting member to be connected to each of the second partition member and the other first partition member.

5. The electricity storage device according to claim 4, further comprising a plurality of fastening members, wherein:
each of the fastening members includes a head portion and a shaft portion connected to the head portion;
each of the plurality of electricity storage modules includes a first side surface and a second side surface arranged in the first direction;
the second partition member includes one second partition member extending in the second direction along the first side surface, and another second partition member extending in the second direction along the second side surface;
the one connecting member includes a first connecting piece for connecting the one first partition member and the one second partition member to each other, and a second connecting piece for connecting the one first partition member and the other second partition member to each other;
the other connecting member includes a third connecting piece for connecting the other first partition member and the one second partition member to each other;
the fastening members include a first fastening member for fastening the first connecting piece and the one first partition member to each other, a second fastening member for fastening the first connecting piece and the one second partition member to each other, a third fastening member for fastening the second connecting piece and the one first partition member, and a fourth fastening member for fastening the third connecting piece and the one second partition member;
a distance between the first fastening member and the third fastening member is smaller than a distance between the second fastening member and the fourth fastening member; and
each of a length of the shaft portion of the first fastening member and a length of the shaft portion of the third fastening member is smaller than each of a length of the shaft portion of the second fastening member and a length of the shaft portion of the fourth fastening member.
